(19) United States
(12) Patent Application Publication
(10) Pub. No.: US 2026/0044106 A1
(43) Pub. Date: Feb. 12, 2026

(54) IMAGE FORMING APPARATUS

(71) Applicant: CANON KABUSHIKI KAISHA, Tokyo (JP)

(72) Inventor: ICHIRO FUKADA, Shizuoka (JP)

(21) Appl. No.: 19/282,756

(22) Filed: Jul. 28, 2025

(30) Foreign Application Priority Data
Aug. 8, 2024 (JP) 2024-133339

(51) Int. Cl. G03G 21/16; G03G 15/00; G03G 15/16

(52) U.S. Cl. CPC G03G 21/1609; G03G 15/1615; G03G 15/6502; G03G 15/751; G03G 21/1619; G03G 2215/00379; G03G 2215/1623

(57) ABSTRACT

First and second cover portions are arranged above a loading tray and below a transfer belt and overlap a loading surface and the transfer belt. When the loading tray in an extension state moves from a pulled-out position to a mounted position, the second cover portion moves in a mounting direction by movement of the loading tray. When the loading tray in the extension state is located in the mounted position, a protruding portion of the loading tray is located downstream of the housing in the mounting direction, and the second cover portion covers the protruding portion from above. When the loading tray is located in the mounted position, at least a part of the second cover portion has an area located downstream of a first cover downstream end in the mounting direction and overlapping the transfer belt and the loading surface, viewed in the direction of gravitational force.

### BACKGROUND

### Field of the Technology

Aspects of the present disclosure generally relate to an image forming apparatus which forms an image on a recording material.

### Description of the Related Art

In the field of image forming apparatuses of the electrophotographic method, an intermediate transfer method, which primarily transfers a toner image from a photosensitive drum to an intermediate transfer belt, conveys the primarily transferred toner image to a secondary transfer portion by the intermediate transfer belt, and then transfers the toner image to a recording material at the secondary transfer portion, is in widespread use. In such an image forming apparatus, a loading tray for containing recording materials may be arranged below the intermediate transfer belt. In this case, a configuration in which, to protect recording materials contained in the loading tray from, for example, toner or dust falling from the intermediate transfer belt, a plate-like protection member is provided between the intermediate transfer belt and the loading tray is known as discussed in Japanese Patent Application Laid-Open No. 2016-038492. In this image forming apparatus, the protection member is arranged above the entire area of the loading tray, except a feeding portion thereof.

On the other hand, with regard to loading trays, a loading tray which allows, in addition to standard size sheets, long sheets (i.e., sheets that are longer than the standard size sheets) provided as recording materials that are to be contained therein is discussed in Japanese Patent Application Laid-Open No. 2012-058295. This loading tray is configured to be able to shorten, for the purpose of miniaturizing an apparatus, when containing standard size sheets and to extend when containing long sheets. The image forming apparatus using this loading tray is configured in such a manner that, when the loading tray containing long sheets has been mounted to the image forming apparatus, parts of the loading tray and the recording materials (long sheets) protrude outside of the main body of the apparatus. Therefore, to protect recording materials that protrude outside of the main body of the apparatus from dust or from being smudged, a dustproof cover is provided at the main body of the apparatus. The dustproof cover is configured to move in a mounting direction of the loading tray in conjunction with the position of a front edge portion in the mounting direction of the loading tray. Thus, when the loading tray has protruded outside of the main body of the apparatus, the dustproof cover (protection cover) also moves outside of the main body of the apparatus in conjunction with the loading tray, to protect the long sheets.

### SUMMARY

Aspects of the present disclosure are generally directed to providing an image forming apparatus capable of attaining miniaturization with regard to the height of the main body of the image forming apparatus.

An aspect of the present disclosure provides an image forming apparatus that includes a housing; a photosensitive member on which to form a toner image; a containing portion having a loading surface on which to load a sheet, the containing portion configured to contain the sheet and to move along a mounting direction extending between a pulled-out position, in which the containing portion has been pulled out from the housing, and a mounted position, in which the containing portion has been mounted to the housing by being moved in a mounting direction from the pulled-out position; a feeding portion configured to feed the sheet contained in the containing portion; a transfer belt arranged above the containing portion and configured to allow the toner image to be transferred thereto from the photosensitive member, and to transfer the toner image to the sheet fed by the feeding portion; a first cover portion arranged above the containing portion and below the transfer belt, the first cover portion overlapping the loading surface and the transfer belt; and a second cover portion arranged between the containing portion and the transfer belt, and overlapping the loading surface and the transfer belt. The containing portion includes a main body portion and an extension portion movable in the mounting direction relative to the main body portion. The containing portion is configured to transition between a first state having a first length in the mounting direction and a second state having a second length in the mounting direction longer than the first length. When the containing portion moves from the pulled-out position to the mounted position in the second state, the second cover portion moves in the mounting direction in conjunction with movement of the containing portion. In a case where the containing portion is located in the mounted position in the second state, a part of the containing portion is located downstream of a housing downstream end provided at a downstream side in the mounting direction and the second cover portion covers the part of the containing portion. In a case where the containing portion is located in the mounted position, at least a part of the second cover portion is located downstream of a downstream end in the mounting direction of the first cover portion and overlaps the transfer belt and the loading surface.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view illustrating an image forming apparatus according to a first exemplary embodiment.

FIGS. 2A and 2B are perspective views illustrating a loading tray according to the first exemplary embodiment, in which FIG. 2A illustrates a normal state of the loading tray and FIG. 2B illustrates an extension state of the loading tray.

FIGS. 3A and 3B are diagrams illustrating a state in which the loading tray being in the normal state has been mounted to the main body of the image forming apparatus according to the first exemplary embodiment, in which FIG. 3A is a side view and FIG. 3B is a sectional view.

FIGS. 4A and 4B are diagrams illustrating a state in which the loading tray being in the extension state is in the middle of being mounted to the main body of the image forming apparatus according to the first exemplary embodiment, in which FIG. 4A is a side view and FIG. 4B is a sectional view.

FIGS. 5A and 5B are diagrams illustrating a state in which the loading tray being in the extension state has been mounted to the main body of the image forming apparatus according to the first exemplary embodiment, in which FIG. 5A is a side view and FIG. 5B is a sectional view.

FIGS. 6A and 6B are schematic diagrams illustrating a relationship between a first cover portion, a second cover portion, a secondary transfer belt, and a loading surface according to the first exemplary embodiment as viewed from above, in which FIG. 6A illustrates the normal state of the loading tray and FIG. 6B illustrates the extension state of the loading tray.

FIGS. 7A and 7B are perspective views illustrating a loading tray according to a second exemplary embodiment, in which FIG. 7A illustrates a normal state of the loading tray and FIG. 7B illustrates an extension state of the loading tray.

FIG. 8 is a sectional view illustrating a state in which the loading tray being in the normal state has been mounted to the main body of an image forming apparatus according to the second exemplary embodiment.

FIGS. 9A and 9B are sectional views illustrating states in which to mount the loading tray being in the extension state to the main body of the image forming apparatus according to the second exemplary embodiment, in which FIG. 9A illustrates a state in which the loading tray is in the middle of being mounted and FIG. 9B illustrates a state in which the loading tray has been mounted.

FIGS. 10A and 10B are perspective views illustrating a loading tray according to a third exemplary embodiment, in which FIG. 10A illustrates a normal state of the loading tray and FIG. 10B illustrates an extension state of the loading tray.

FIG. 11 is a sectional view illustrating a state in which the loading tray being in the normal state has been mounted to the main body of an image forming apparatus according to the third exemplary embodiment.

FIGS. 12A and 12B are sectional views illustrating states in which to mount the loading tray being in the extension state to the main body of the image forming apparatus according to the third exemplary embodiment, in which FIG. 12A illustrates a state in which the loading tray is in the middle of being mounted and FIG. 12B illustrates a state in which the loading tray has been mounted.

### DESCRIPTION OF THE EMBODIMENTS

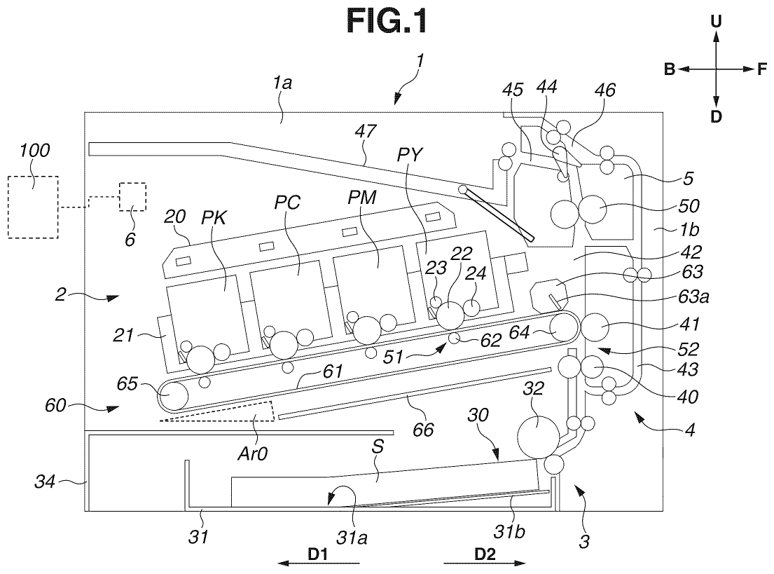

In the following description, a first exemplary embodiment of the present disclosure is described with reference to FIG. 1 to FIGS. 6A and 6B.

First, an outline configuration of an image forming apparatus 1 according to the first exemplary embodiment is described with reference to FIG. 1. Unless otherwise stated, for example, the dimensions, materials, and relative positions of the respective constituent components of the image forming apparatus 1 are not intended to limit the scope of the present disclosure.

### Image Forming Apparatus

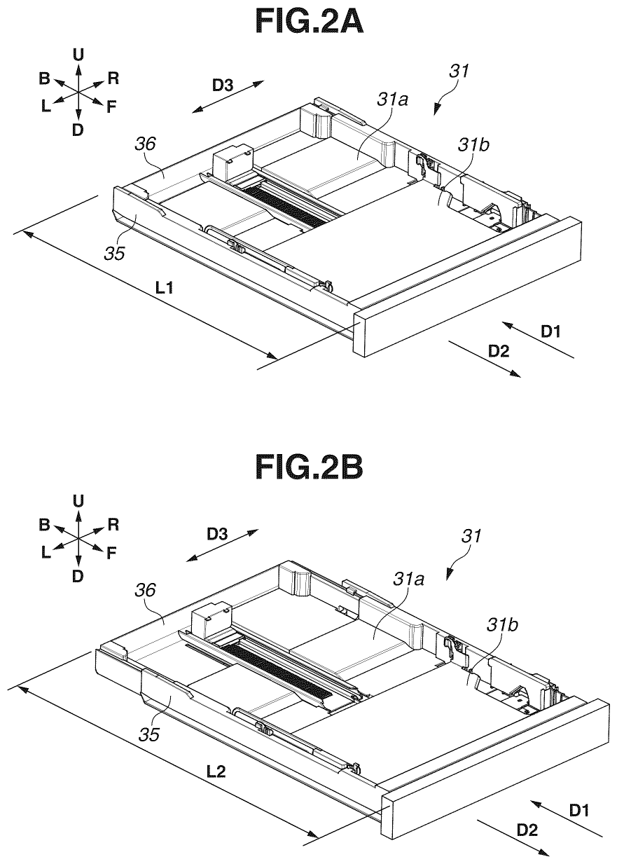

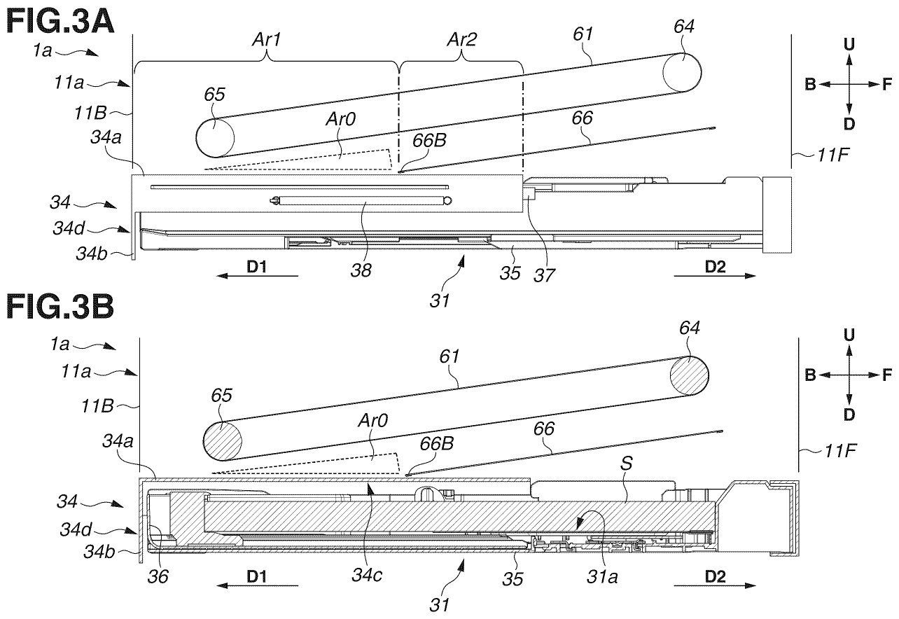

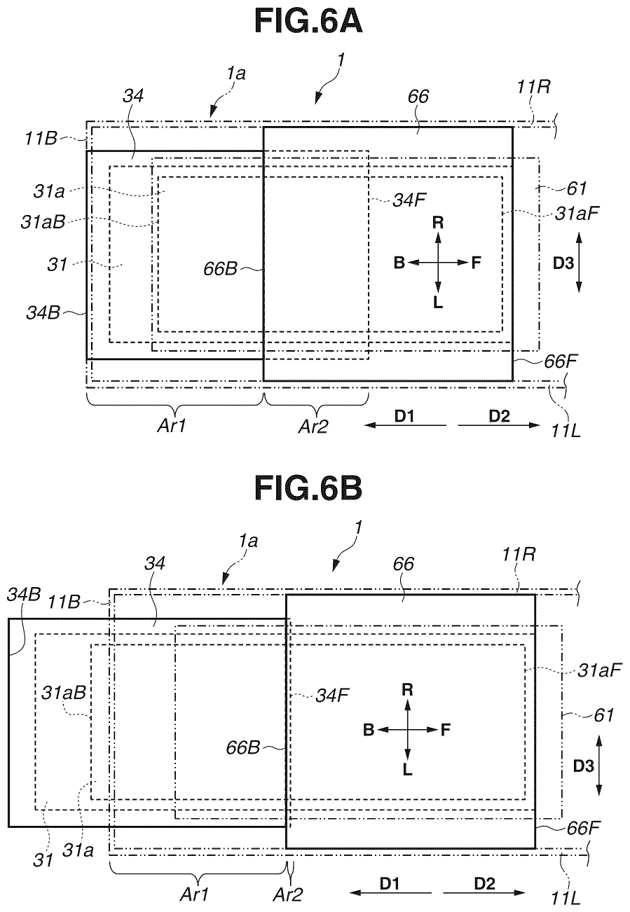

FIG. 1 is an outline diagram of the image forming apparatus 1 according to the first exemplary embodiment. In the first exemplary embodiment, the image forming apparatus 1 is a color laser beam printer of the electrophotographic method, which forms an image on a sheet S serving as a recording material. The image forming apparatus 1 includes a housing 1a and a door 1b, which is provided in such a way as to be able to open and close the front face of the housing 1a. Moreover, the image forming apparatus 1 includes, for example, an image forming unit 2, a sheet feeding unit 3, a sheet conveyance unit 4, a fixing device 5, and a control unit 6 while containing them inside the housing 1a. In the first exemplary embodiment, directions in which to demount and mount a loading tray 31 from and to the image forming apparatus 1 are defined as frontward and backward directions, and directions parallel to the direction of gravitational force are defined as upward and downward directions. Moreover, in each figure, regarding the frontward and backward directions, the direction facing the front side is defined as a frontward direction F and the direction facing the back side is defined as a backward direction B. Regarding the upward and downward directions, the direction extending upward is defined as an upward direction U and the direction extending downward is defined as a downward direction D, and, as viewed from the front side, the direction facing the right side is defined as a rightward direction R and the direction facing the left side is defined as a leftward direction L (refer to, for example, FIG. 2A). The housing la includes a front cover 11F, a back cover 11B, a right side wall 11R, and a left side wall 11L (refer to FIG. 3A and FIG. 6A).

The sheet feeding unit 3 includes a loading tray 31, which allows a sheet S serving as a recording material to be loaded thereon, and a feeding roller 32. The feeding roller 32 is an example of a feeding portion, which feeds a sheet S contained in the loading tray 31. In the first exemplary embodiment, a pulling-out direction D2 is a direction parallel to a feeding direction in which the feeding roller 32 feeds the sheet S. Thus, a mounting direction D1 is a direction opposite to the pulling-out direction D2 and is a direction advancing from the downstream side to the upstream side in the feeding direction.

The loading tray 31 is configured to be mountable to the housing 1a of the image forming apparatus 1 by being inserted into the housing 1a in the mounting direction D1 and to be demountable from the housing 1a by being pulled out from the housing 1a in the pulling-out direction D2. Here, the mounting direction DI and the pulling-out direction D2 are directions along the horizontal direction. Thus, the loading tray 31 is an example of a containing portion, has a loading surface 31a on which to load the sheet S, and contains the sheet S therein. The loading tray 31 includes a lifting plate 31b at the downstream side in the pulling-out direction D2 in the bottom portion thereof, and the lifting plate 31b is configured to rise in such a manner that the uppermost sheet S in a sheet stack contained in the loading tray 31 is fed by the feeding roller 32. In the interior of the loading tray 31, the loading surface 31a is set as a surface which includes at least a region on which a sheet S with the maximum size available for image formation by the image forming apparatus 1 is loadable with inclusion of a portion in which the lifting plate 31b is present and a portion in which the lifting plate 31b is absent. Thus, since it is desirable to prevent falling of toner in a region broader than the region on which the sheet S with the maximum size is loadable, such a region is set as the loading surface 31a.

The loading tray 31 is configured to be mountable to the housing 1a in the mounting direction D1 and to be demountable from the housing 1a in the pulling-out direction D2, which is a direction opposite to the mounting direction D1. In this way, the loading tray 31 takes a pulled-out position, in which the loading tray 31 has been pulled out from the housing 1a, and a mounted position, in which the loading tray 31 has been mounted to the housing 1a by being moved in the mounting direction D1 from the pulled-out position. While, in the first exemplary embodiment, the mounting direction D1 is set as the backward direction B and the pulling-out direction D2 is set as the frontward direction F, the mounting direction D1 and the pulling-out direction D2 are not limited to the backward and frontward directions. Above the loading tray 31 at the side to which the mounting direction D1 advances, a second cover portion 34 serving as a dustproof cover is provided to protect sheets S contained in the loading tray 31 from dust or from being smudged. The second cover portion 34 is described below.

The image forming unit 2 includes, for example, process cartridges PY, PM, PC, and PK, an exposure device 20, and a transfer unit 60. The process cartridges PY, PM, PC, and PK are supported by a tray 21 in such a way as to be attachable to and detachable from the tray 21 independent from one another, and contain respective toners (developers) of yellow (Y), magenta (M), cyan (C), and black (K). Since the process cartridges PY, PM, PC, and PK have the same configuration except that the respective contained toners differ in color. For conciseness, the process cartridge PY of yellow is described as an example. The process cartridge PY includes a photosensitive drum 22 compatible with toner of yellow, a charging roller 23, and a developing roller 24. The photosensitive drum 22 is an example of a photosensitive member, on which a toner image corresponding to each toner color is formed and borne. The direction of a rotation axis D3 of the photosensitive drum 22 corresponds to the rightward and leftward directions (R and L, refer to FIG. 2A), i.e., a sheet width direction perpendicular to the conveyance direction of a sheet S to be conveyed.

The transfer unit 60 includes an intermediate transfer belt 61, a primary transfer roller 62, a cleaning unit 63, a drive roller 64, which drives the intermediate transfer belt 61, and a tension roller 65, which applies a tension to the intermediate transfer belt 61. Thus, the intermediate transfer belt 61 is suspended in a tensioned manner by the drive roller 64, which is an example of a first roller, and the tension roller 65, which is an example of a second roller arranged downstream of the drive roller 64 in the mounting direction D1. The intermediate transfer belt 61 is an example of a transfer belt, which is arranged above the loading tray 31 inside the housing 1a and in the upward and downward directions, to which a toner image is transferred from the photosensitive drum 22, and which transfers the transferred toner image to a sheet S fed by the feeding roller 32. In the first exemplary embodiment, the photosensitive drum 22 is arranged above the intermediate transfer belt 61 in the upward and downward directions. The intermediate transfer belt 61 is in abutting contact with the photosensitive drum 22, and thus forms a primary transfer portion 51 for primarily transferring a toner image borne on the photosensitive drum 22 to the intermediate transfer belt 61.

Below the intermediate transfer belt 61, a first cover portion 66, which serves as a protection member for preventing toner having fallen from the intermediate transfer belt 61 from reaching the loading tray 31, is arranged. This prevents sheets S contained in the loading tray 31 from being smudged due to falling of toner that is remaining on the intermediate transfer belt 61. Thus, the first cover portion 66 is provided in the housing 1a and is arranged in between the loading tray 31 and the intermediate transfer belt 61 in the upward and downward directions, thus covers the upside of the loading tray 31. In the first exemplary embodiment, the first cover portion 66 is assumed to be a portion configured with, for example, a flat plate-like member.

Here, as illustrated in FIG. 6A, the housing 1a includes a right side wall 11R and a left side wall 11L, which are side walls provided along respective opposite sides in the rightward and leftward directions, which correspond to the direction of the rotation axis D3 of the photosensitive drum 22.

FIGS. 6A and 6B are schematic diagrams, so that the aspect length-to-width ratio of each member is different from the actual one. The first cover portion 66 is supported, at both side portions thereof in the direction of rotation axis D3, by the right side wall 11R and the left side wall 11L of the housing la. The first cover portion 66 being supported by the right side wall 11R and the left side wall 11L mentioned here is not limited to the first cover portion 66 being directly supported by the right side wall 11R and the left side wall 11L. For example, the first cover portion 66 being supported by the right side wall 11R and the left side wall 11L also includes the first cover portion 66 being indirectly supported by the right side wall 11R and the left side wall 11L, such as the first cover portion 66 being supported by a frame supporting the right side wall 11R and the left side wall 11L or the first cover portion 66 being supported via a different member attached to the right side wall 11R and the left side wall 11L. The first cover portion 66 is arranged above the loading tray 31 and below the intermediate transfer belt 61, and overlaps the loading surface 31a and the intermediate transfer belt 61 as viewed in the direction of gravitational force.

As illustrated in FIG. 1, the sheet conveyance unit 4 includes a registration roller pair 40, which conveys a sheet S fed from the feeding roller 32, and a secondary transfer roller 41, which is arranged downstream of the registration roller pair 40 in the sheet conveyance direction. The intermediate transfer belt 61 and the secondary transfer roller 41 form a secondary transfer portion 52 for transferring a toner image primarily transferred to the intermediate transfer belt 61 to a sheet S fed by the feeding roller 32. The registration roller pair 40 corrects skewing of the sheet S and performs adjustment in such a way as to align timing for conveying the sheet S to the secondary transfer portion 52 with a toner image borne on the intermediate transfer belt 61. The fixing device 5 includes a fixing roller pair 50, which includes a heating roller and pressure roller.

### Image Forming Operation

An image forming operation of the image forming apparatus 1 is described with reference to FIG. 1. The control unit 6 of the image forming apparatus 1 starts an image forming operation on a sheet S based on an image signal received from an external host device 100. The external host device 100 is, for example, a personal computer, an image reader, or a facsimile apparatus.

In response to an image forming job being started by the control unit 6, a charging voltage is applied to the charging roller 23 and the photosensitive drum 22 is rotated and is thus charged by the charging roller 23. Laser light corresponding to image information is radiated from the exposure device 20 onto the photosensitive drum 22, so that the charged surface of the photosensitive drum 22 is exposed to the laser light. This causes an electrostatic latent image corresponding to the image information to be formed on the surface of the photosensitive drum 22. Immediately after that, a developing voltage is applied to the developing roller 24 and the electrostatic latent image formed on the photosensitive drum 22 is developed by toner supplied from the developing roller 24, so that a toner image is formed on the surface of the photosensitive drum 22. Toner images formed on the photosensitive drums 22 of the respective process cartridges PY, PM, PC, and PK are transferred onto the intermediate transfer belt 61 by the respective primary transfer rollers 62, so that the transferred toner images are conveyed toward the secondary transfer portion 52, which is formed by the intermediate transfer belt 61 and the secondary transfer roller 41.

On the other hand, in the housing la of the image forming apparatus 1, a conveyance path 42, through which a sheet S heading for the fixing device 5 passes, is formed. Moreover, in the door 1b, a two-sided conveyance path 43, through which a sheet S having passed through the fixing device 5 passes, is formed. In the sheet feeding unit 3, from sheets S loaded on the loading tray 31, one sheet S is separated and fed by the feeding roller 32 at predetermined timing and is then conveyed through the conveyance path 42 toward the secondary transfer portion 52 and the fixing device 5.

In the secondary transfer portion 52, the toner images are transferred from the intermediate transfer belt 61 to the sheet S.

Toner which has not been transferred to the sheet S is removed from the intermediate transfer belt 61 by a cleaning blade 63a provided inside a cleaning unit 63. The sheet S with the toner images transferred thereto at the secondary transfer portion 52 is conveyed toward the fixing device 5. In the fixing device 5, the sheet S is heated and pressed by the fixing roller pair 50, so that the toner images are fixed to the sheet S. The sheet S with the toner images fixed thereto is conveyed toward a discharging reversing portion 44.

The discharging reversing portion 44 is movable between a discharging position for guiding the sheet S having passed through the fixing device 5 toward a discharging path 45 and a reversing position for guiding the sheet S having passed through the fixing device 5 toward a reversing path 46. In a case where one-sided printing, in which an image is formed on one side of a sheet S, is performed, the sheet S is guided to the discharging path 45 by the discharging reversing portion 44 and is then discharged to a discharge tray 47 formed at an upper portion of the image forming apparatus 1. On the other hand, in a case where two-sided printing, in which images are formed on both sides of a sheet S, is performed, the sheet S is guided to the reversing path 46 by the discharging reversing portion 44. After the sheet S is guided to the reversing path 46, the conveyance direction of the sheet S is reversed, so that the sheet S passes through the two-sided conveyance path 43 formed in the door 1b and is then conveyed toward the secondary transfer portion 52 again. In the secondary transfer portion 52, toner images are transferred to the back surface of the sheet S, and then, the sheet S passes through the fixing device 5, is guided to the discharging path 45 by the discharging reversing portion 44, and is then discharged to the discharge tray 47 of the image forming apparatus 1.

### Configurations of Loading Tray and Second Cover Portion

A configuration of the loading tray 31 is described in detail with reference to FIGS. 2A and 2B. The loading tray 31 includes a tray main body 35, which is an example of a main body portion, and an extension portion 36, which is provided in such a way as to be movable in the mounting direction D1 and the pulling-out direction D2 with respect to the tray main body 35. FIG. 2A illustrates a normal state in which the loading tray 31 has become shortened with the extension portion 36 located at the side having moved in the pulling-out direction D2, and FIG. 2B illustrates an extension state in which the loading tray 31 has become extended with the extension portion 36 located at the side having moved in the mounting direction D1. Thus, the loading tray 31 is able to transition between the normal state and the extension state. The normal state is an example of a first state and is a state in which the length (total length) in the mounting direction D1 of the loading tray 31 is set as a first length L1. The extension state is an example of a second state and is a state in which, with the extension portion 36 having been moved in the mounting direction D1 with respect to the tray main body 35, the length (total length) in the mounting direction D1 of the loading tray 31 is set as a second length L2 longer than the first length L1. The loading tray 31 being in the normal state allows, for example, sheets of standard sizes such as A4 size to be contained therein, and the loading tray 31 being in the extension state allows long sheets (sheets longer than the standard size sheets) to be contained therein. This enables the user to, when loading long sheets on the loading tray 31, extend the loading tray 31 with use of the extension portion 36 to enlarge a containing region for sheets S to be loaded.

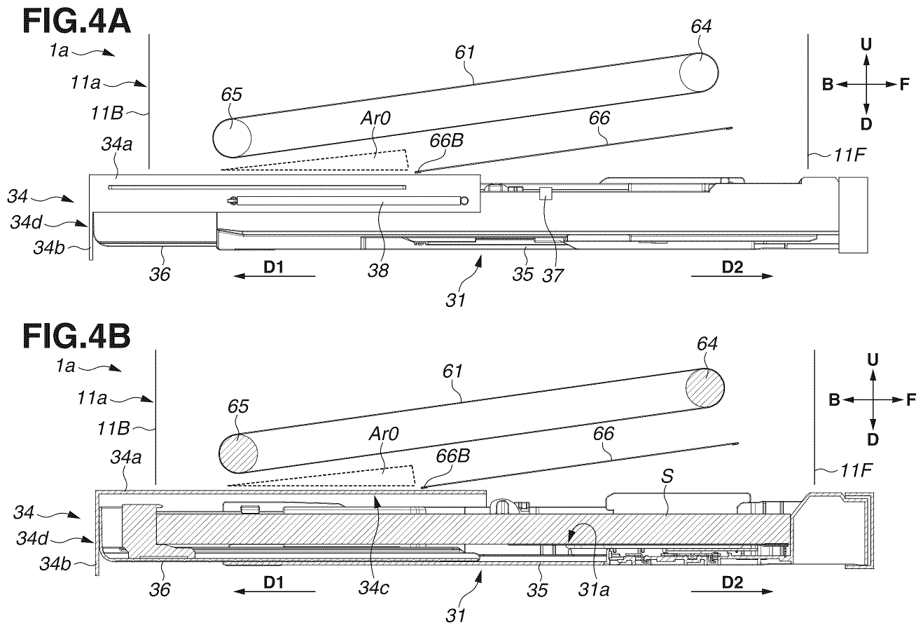

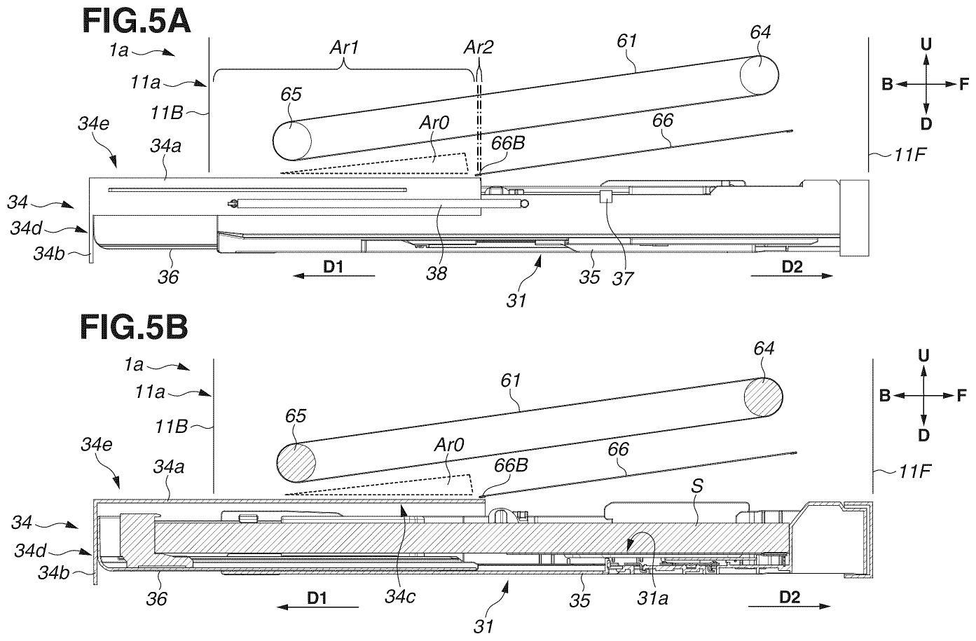

A configuration and operation of the second cover portion 34, which is a feature of the first exemplary embodiment, are described in detail with reference to FIGS. 3A and 3B to FIGS. 6A and 6B. The second cover portion 34 is movable in the frontward and backward directions relative to the housing 1a, and includes a top plate portion 34a and a back plate portion 34b. The top plate portion 34a has an approximately flat plate shape which covers the upside of the loading tray 31 and is provided to extend in the horizontal direction, and protects, from dust or from being smudged, sheets S contained in the loading tray 31. The top plate portion 34a includes a cover surface 34c, which covers the upside of the loading tray 31 in conjunction with the first cover portion 66 in the upward and downward directions. In the first exemplary embodiment, the lower surface of the top plate portion 34a serves as the cover surface 34c and covers the upside of the loading tray 31 (refer to FIG. 3B, FIG. 4B, and FIG. 5B). The second cover portion 34 is arranged above the loading tray 31 and below the intermediate transfer belt 61, and overlaps the loading surface 31a and the intermediate transfer belt 61 as viewed in the direction of gravitational force.

The back plate portion 34b has an approximately flat plate shape provided to consecutively extend downward from an end portion at the side in the backward direction B of the top plate portion 34a, and is arranged away from the loading tray 31 in the backward direction B. Thus, the back plate portion 34b is an example of a side plate portion, and is provided to extend in the vertical direction at the downstream portion in the mounting direction D1 of the second cover portion 34. On the other hand, the back cover 11B has, in an exterior surface, a downstream end surface 11a of the housing 1a in the mounting direction D1. The downstream end surface 11a is an example of a housing downstream end, which is an end portion at the downstream side in the mounting direction D1 of the housing 1a. The back plate portion 34b is able to constitute a part of the exterior of the image forming apparatus 1 when being located on the same plane as the downstream end surface 11a of the housing 1a. Thus, the back plate portion 34b constitutes a part of the downstream end portion in the mounting direction D1 of the image forming apparatus 1.

The state in which the loading tray 31 being in the normal state, in which the loading tray 31 is not extended with use of the extension portion 36, has been inserted into and mounted to the image forming apparatus 1 is described with reference to FIGS. 3A and 3B. FIGS. 3A and 3B are a side view and a sectional view, respectively. The second cover portion 34 is supported by rail members inside the image forming apparatus 1 in such a way as to be movable in the mounting direction D1 and the pulling-out direction D2 of the loading tray 31. Moreover, the second cover portion 34 is connected to the housing 1a of the image forming apparatus 1 via an elastic member 38 made from an extension coil spring. The elastic member 38 is an example of an urging portion, and urges the second cover portion 34 toward a first position. While, in the first exemplary embodiment, a case where an extension coil spring is applied as the elastic member 38 is described, the first exemplary embodiment is not limited to this case. For example, a compression coil spring, a plate spring, or a torsion coil spring can be applied.

The second cover portion 34 receives an urging force in the pulling-out direction D2 of the loading tray 31 from the elastic member 38 and collides with a collision portion 37 provided at the housing 1a in the state of the entire second cover portion 34 being contained in the housing 1a, so that the second cover portion 34 is located at the first position in which the second cover portion 34 waits inside the housing 1a. At this time, the back plate portion 34b of the second cover portion 34 constitutes the exterior of the image forming apparatus 1. Even in a state in which the loading tray 31 has been pulled out from the image forming apparatus 1, the second cover portion 34 is kept located at the first position.

Below the intermediate transfer belt 61, the first cover portion 66 and the second cover portion 34 are arranged in such a way as to protect sheets S contained in the loading tray 31. Here, the downstream end in the mounting direction D1 of the first cover portion 66 is referred to as a “first cover downstream end 66B”. In a case where the loading tray 31 is located in the mounted position, at least a part of the second cover portion 34 has a portion which is located downstream of the first cover downstream end 66B in the mounting direction D1 and overlaps the intermediate transfer belt 61 and the loading surface 31a as viewed in the direction of gravitational force. This portion is referred to as a “region Ar1”. At this time, an upstream end 34F (refer to FIG. 6A) in the mounting direction D1 of the second cover portion 34 is located upstream of the first cover downstream end 66B. Thus, the top plate portion 34a of the second cover portion 34 has the area Ar1, which, when the second cover portion 34 is located in the first position, is located below the intermediate transfer belt 61 in the upward and downward directions and does not overlap the first cover portion 66 as viewed in the upward and downward directions. The area Ar1 is not limited to an area immediately below the intermediate transfer belt 61, but includes an area which is not immediately below the intermediate transfer belt 61 but is located below the intermediate transfer belt 61 without overlapping the first cover portion 66.

The top plate portion 34a has an area Ar2, which, when the second cover portion 34 is located in the first position, is located below the intermediate transfer belt 61 in the upward and downward directions and overlaps the first cover portion 66 as viewed in the upward and downward directions. Thus, the first cover downstream end 66B, which is a downstream end in the mounting direction D1 of the first cover portion 66, overlaps the second cover portion 34 as viewed in the direction of gravitational force. The image forming apparatus 1 is provided with an area Ar0 in which, as viewed in the upward and downward directions, the second cover portion 34 and the first cover portion 66 do not overlap each other, the first cover portion 66 does not exist between the intermediate transfer belt 61, the loading tray 31, and the sheet S, and only the second cover portion 34 exists therebetween.

In a case where the loading tray 31 is located in the mounted position, as illustrated in FIG. 6A, an upstream end 66F in the mounting direction D1 of the first cover portion 66 is located upstream of an upstream end 31aF of the loading surface 31a. At the same time, a downstream end 34B in the mounting direction D1 of the second cover portion 34 is located downstream of a downstream end 31aB of the loading surface 31a. In the rightward and leftward directions, the length of the first cover portion 66 is longer than the length of the loading surface 31a, and the length of the second cover portion 34 is longer than the length of the loading surface 31a. This causes the entire area of the loading surface 31a to be covered by the first cover portion 66 and the second cover portion 34 as viewed in the upward and downward directions, thus enabling effectively preventing toner having fallen from the intermediate transfer belt 61 from reaching the loading tray 31.

In the first exemplary embodiment, as viewed in the upward and downward directions, the first cover portion 66 is arranged in such a way as to overlap the drive roller 64 and in such a way as not to overlap the tension roller 65. On the other hand, as viewed in the upward and downward directions, the second cover portion 34 is arranged in such a way as not to overlap the drive roller 64 and in such a way as to overlap the tension roller 65.

The back plate portion 34b has a cover end surface 34d located at a downstream end in the mounting direction D1. The cover end surface 34d is flush with the downstream end surface 11a of the housing 1a when the second cover portion 34 is located in the first position. Flushness, as mentioned herein, only needs to substantially mean flushness, and, even if there is a deviation by, for example, about 1 cm in the mounting direction D1, such a deviation is also deemed as flushness.

Next, a case where the loading tray 31 being in the extension state, in which the loading tray 31 has been extended with use of the extension portion 36, is inserted into the image forming apparatus 1 is described with reference to FIGS. 4A and 4B. FIGS. 4A and 4B are a side view and a sectional view, respectively, taken when the loading tray 31 has been inserted into the image forming apparatus 1. At this time, a front edge portion in the mounting direction D1 of the extension portion 36 collides with the back plate portion 34b of the second cover portion 34 from the side in the frontward direction F, so that the second cover portion 34 moves in the mounting direction D1. Thus, in a case where the loading tray 31 being in the extension state moves from the pulled-out position to the mounted position, the second cover portion 34 moves in the mounting direction D1 in association with the movement of the loading tray 31. The second cover portion 34 is receiving an urging force in the pulling-out direction D2 from the elastic member 38. However, the urging force of the elastic member 38 only needs to have a magnitude capable of moving the second cover portion 34 with no external force acting thereon to a position for colliding with the collision portion 37, and is thus set as a minute force slightly larger than a frictional force occurring between the second cover portion 34 and the rail members. Therefore, the urging force of the elastic member 38 does not obstruct an insertion operation for the loading tray 31, and, even if the user loses hold of the loading tray 31 during the process of operation, the loading tray 31 is not caused to move in the pulling-out direction D2.

FIGS. 5A and 5B are a side view and a sectional view, respectively, illustrating a state in which the loading tray 31 being in the extension state, in which the loading tray 31 has been extended with use of the extension portion 36, has been completely mounted to the image forming apparatus 1 and the second cover portion 34 is located in a second position. At this time, the extension portion 36 and the second cover portion 34 are in a state in which parts thereof have protruded in the mounting direction D1 from the back cover 11B at the back of the housing 1a, so that the second cover portion 34 is protecting, from dust or from being smudged, sheets S having protruded to the outside of the housing 1a. Thus, the second position is a position which is located downstream of the first position in the mounting direction D1 and in which at least parts of the extension portion 36 and the second cover portion 34 protrude to the downstream side from the outer surface (downstream end surface 11a) of the back cover 11B, which is a housing downstream end of the housing 1a, in the mounting direction D1.

The second cover portion 34 is movable between the first position illustrated in FIGS. 3A and 3B and the second position illustrated in FIGS. 5A and 5B. Then, when the loading tray 31 being in the extension state is mounted to the housing 1a and the second cover portion 34 is located in the second position, the second cover portion 34 covers the upside of a portion of the loading tray 31 having protruded to the downstream side from the back cover 11B of the housing 1a in the mounting direction D1. Thus, in a case where the loading tray 31 being in the extension state is located in the mounted position, a protruding portion 34e, which is a part of the loading tray 31, is located downstream of the downstream end surface 11a of the housing 1a in the mounting direction D1 and the second cover portion 34 covers the protruding portion 34e of the loading tray 31 from above. The second cover portion 34 receives an urging force in the pulling-out direction D2 from the elastic member 38, but collides with the loading tray 31 and is at a stop there. Since the urging force is a minute force as mentioned above, in the state in which the loading tray 31 has been completely inserted into the housing 1a, the loading tray 31 is not caused by the urging force to move in the pulling-out direction D2.

At this time, below the intermediate transfer belt 61, the first cover portion 66 and the second cover portion 34 are arranged in such a way as to protect sheets S contained in the loading tray 31. Here, in a case where the loading tray 31 is located in the mounted position, at least a part of the second cover portion 34 has a portion which is located downstream of the first cover downstream end 66B in the mounting direction D1 and overlaps the intermediate transfer belt 61 and the loading surface 31a as viewed in the direction of gravitational force. This portion is referred to as an area Ar1 as with the case illustrated in FIG. 3A. At this time, the upstream end 34F (refer to FIG. 6B) in the mounting direction D1 of the second cover portion 34 is located upstream of the first cover downstream end 66B. Thus, the top plate portion 34a of the second cover portion 34 has an area Ar1 which, when the second cover portion 34 is located in the second position, is located below the intermediate transfer belt 61 in the upward and downward directions and does not overlap the first cover portion 66 as viewed in the upward and downward directions.

The top plate portion 34a has an area Ar2 which, when the second cover portion 34 is located in the second position, is located below the intermediate transfer belt 61 in the upward and downward directions and overlaps the first cover portion 66 as viewed in the upward and downward directions. Thus, even when the second cover portion 34 is located in the second position, the first cover downstream end 66B, which is a downstream end in the mounting direction D1 of the first cover portion 66, overlaps the second cover portion 34 as viewed in the direction of gravitational force. Moreover, the image forming apparatus 1 is provided with an area Ar0 in which, as viewed in the upward and downward directions, the second cover portion 34 and the first cover portion 66 do not overlap each other, the first cover portion 66 does not exist between the intermediate transfer belt 61, the loading tray 31, and the sheet S, and only the second cover portion 34 exists therebetween.

In a case where the loading tray 31 is located in the mounted position, as illustrated in FIG. 6B, the upstream end 66F in the mounting direction D1 of the first cover portion 66 is located upstream of the upstream end 31aF of the loading surface 31a. At the same time, the downstream end 34B in the mounting direction D1 of the second cover portion 34 is located downstream of the downstream end 31aB of the loading surface 31a. Moreover, in the rightward and leftward directions, the length of the first cover portion 66 is longer than the length of the loading surface 31a, and the length of the second cover portion 34 is longer than the length of the loading surface 31a. This causes the entire area of the loading surface 31a to be covered by the first cover portion 66 and the second cover portion 34 as viewed in the upward and downward directions, thus enabling effectively preventing toner having fallen from the intermediate transfer belt 61 from reaching the loading tray 31.

In the first exemplary embodiment, the upstream end portion in the mounting direction D1 of the second cover portion 34 is provided in such a way as to slightly overlap the downstream end portion in the mounting direction D1 of the first cover portion 66 when the second cover portion 34 is located in the second position. The amount of overlapping in this instance can be set to an appropriate value such as 5 millimeters (mm) or 1 centimeter (cm). This enables reducing the size of an area in which the second cover portion 34 and the first cover portion 66 overlap each other in the upward and downward directions when the second cover portion 34 is located at a position closer to the side in the pulling-out direction D2 than the second position, such as the first position, thus reducing the height of the image forming apparatus 1. Since the upstream end portion of the second cover portion 34 slightly overlaps the downstream end portion of the first cover portion 66, even if the second cover portion 34 is located anywhere between the first position and the second position, it is possible to prevent toner having fallen from the intermediate transfer belt 61 from reaching the loading tray 31.

While, in the first exemplary embodiment, a case where the upstream end portion of the second cover portion 34 slightly overlaps the downstream end portion of the first cover portion 66 has been described, the first exemplary embodiment is not limited to this case. For example, the upstream end 34F in the mounting direction D1 of the second cover portion 34 can be set substantially coincident with the first cover downstream end 66B. The term “substantially coincident” mentioned here is assumed to include not only a case where the upstream end portion of the second cover portion 34 and the downstream end portion of the first cover portion 66 become completely aligned and coincident with each other but also a case where the upstream end portion of the second cover portion 34 and the downstream end portion of the first cover portion 66 overlap each other by a small length such as about 5 mm.

Moreover, in the first exemplary embodiment, even when the loading tray 31 is in any of the normal state and the extension state, inside the housing 1a, the second cover portion 34 covers, together with the first cover portion 66, the upside of the loading tray 31 at the position below the intermediate transfer belt 61 (refer to FIG. 3B and FIG. 5B). This enables preventing sheets S contained in the loading tray 31 from being smudged due to falling of toner having remained on the intermediate transfer belt 61.

In the first exemplary embodiment, the second cover portion 34 is supported by the housing 1a in such a way as to be movable between the first position and the second position. When the user mounts the loading tray 31 being in the extension state to the housing 1a, the loading tray 31 pushes the second cover portion 34 being located in the first position, thus moving the second cover portion 34 from the first position to the second position. When the user pulls out the loading tray 31 being in the extension state from the housing 1a, the second cover portion 34 moves from the second position to the first position by an urging force of the elastic member 38 in conjunction with the loading tray 31 moving in the pulling-out direction D2.

As mentioned above, according to the image forming apparatus 1 in the first exemplary embodiment, the second cover portion 34 has the area Ar1, which, when the second cover portion 34 is located in the first position, is located below the intermediate transfer belt 61 in the upward and downward directions and does not overlap the first cover portion 66 as viewed in the upward and downward directions. This enables providing an area in which the first cover portion 66 and the second cover portion 34 do not overlap each other in the upward and downward directions, so that it is possible to attain a reduction in size with regard to the height of the apparatus main body. Thus, by avoiding overlapping in the upward and downward directions between the second cover portion 34 and the first cover portion 66, it is possible to reduce the size of the apparatus with regard to the height direction while also preventing sheets S from being smudged inside the apparatus.

According to the image forming apparatus 1 in the first exemplary embodiment, with use of an urging force of the elastic member 38, the second cover portion 34 is moved in conjunction with the motion of the extension portion 36 for extension and contraction, and is thus configured to be movable in the mounting direction D1 and the pulling-out direction D2 of the loading tray 31. Therefore, it is possible to reduce the size in the frontward and backward directions of the image forming apparatus 1 in a case where the loading tray 31 is in the state of not protruding from the housing 1a, while preventing sheets S from being smudged by, for example, dust coming from the outside of the apparatus. In this way, according to the first exemplary embodiment, it is possible to implement satisfying both of a reduction in size in the frontward and backward directions and a reduction in size in the height direction of the loading tray 31 while protecting, from dust or from being smudged, sheets S contained in the loading tray 31.

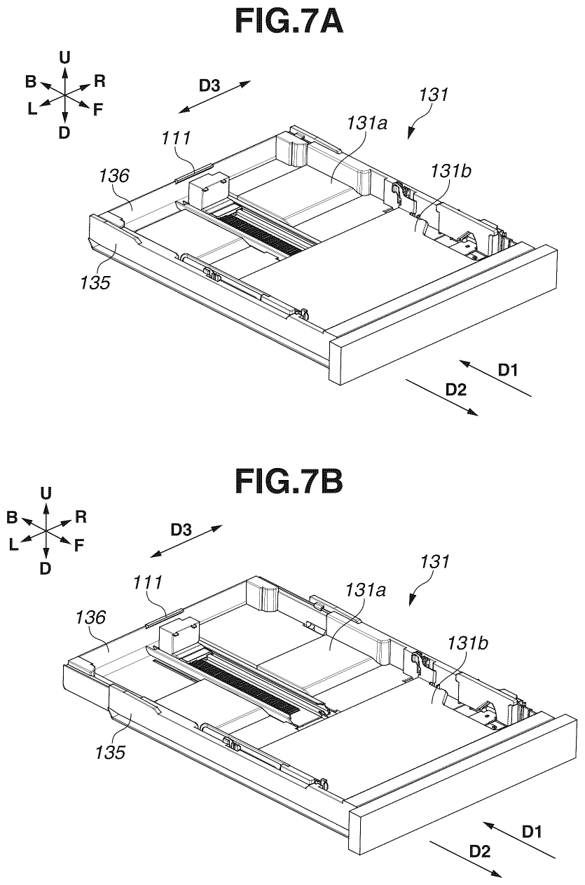

A second exemplary embodiment of the present disclosure is described in detail with reference to FIGS. 7A and 7B to FIGS. 9A and 9B. The configuration of the second exemplary embodiment differs from that of the first exemplary embodiment in that a loading tray 131 and a second cover portion 134 engage with each other and thus interlock in the pulling-out direction D2. However, the other constituent elements are similar to those in the first exemplary embodiment and are assigned the respective same reference characters as those in the first exemplary embodiment, so that the detailed description thereof is omitted here.

### Configurations of Loading Tray and Second Cover Portion

First, a configuration of the loading tray 131 is described with reference to FIGS. 7A and 7B. As with the first exemplary embodiment, the loading tray 131 includes a tray main body 135 and an extension portion 136, which is supported to be able to slide in the mounting direction D1 and the pulling-out direction D2 with respect to the tray main body 135. FIG. 7A illustrates a normal state in which the loading tray 131 has become shortened with the extension portion 136 located at the side having moved in the pulling-out direction D2, and FIG. 7B illustrates an extension state in which the loading tray 131 has become extended with the extension portion 136 located at the side having moved in the mounting direction D1. This configuration enables the user to, when loading long sheets on the loading tray 131, extend the loading tray 131 with use of the extension portion 136 to enlarge a containing region for sheets S to be loaded.

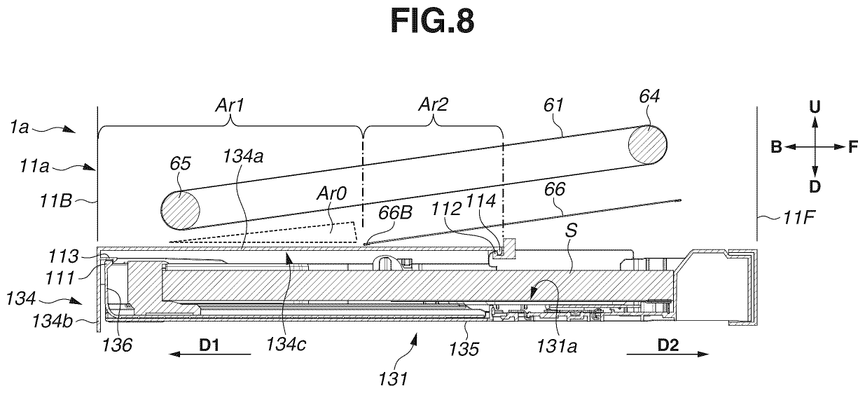

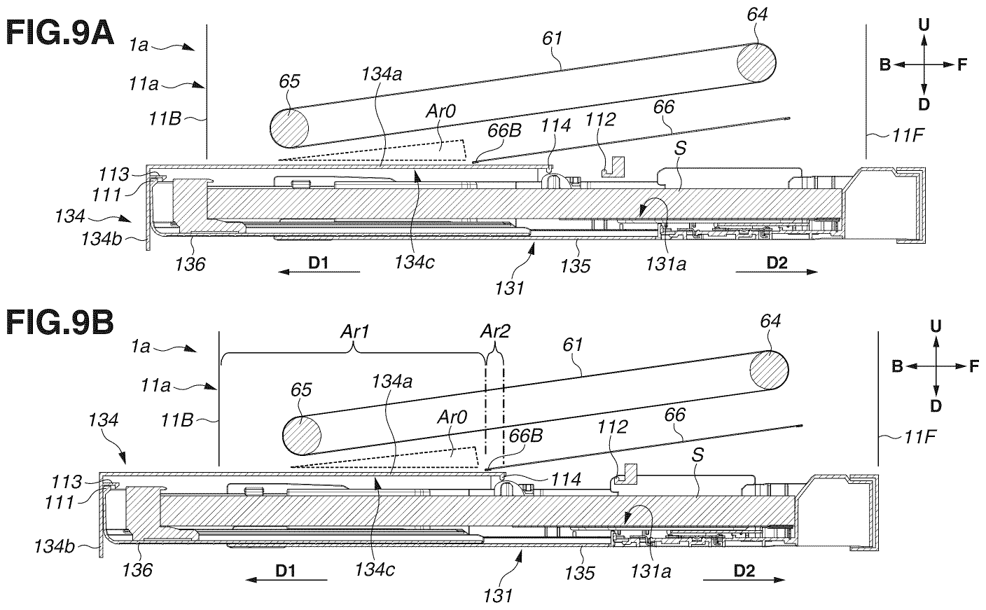

A configuration and operation of the second cover portion 134, which is a feature of the second exemplary embodiment, are described in detail with reference to FIG. 8 and FIGS. 9A and 9B. The state in which the loading tray 131 being in the normal state, in which the loading tray 131 is not extended with use of the extension portion 136, has been inserted into and mounted to the image forming apparatus 1 is described with reference to FIG. 8. As with the first exemplary embodiment, the second cover portion 134 is supported by rail members inside the image forming apparatus 1 in such a way as to be movable in the mounting direction D1 and the pulling-out direction D2 of the loading tray 131.

The second cover portion 134 is movable in the frontward and backward directions relative to the housing 1a, and includes a top plate portion 134a and a back plate portion 134b. The top plate portion 134a has an approximately flat plate shape which covers the upside of the loading tray 131 and is provided to extend in the horizontal direction, and protects, from dust or from being smudged, sheets S contained in the loading tray 131. The second cover portion 134 includes a cover surface 134c, which covers the upside of the loading tray 131 in conjunction with the first cover portion 66 in the upward and downward directions. In the second exemplary embodiment, the lower surface of the top plate portion 134a serves as the cover surface 134c and covers the upside of the loading tray 131. The second cover portion 134 is arranged above the loading tray 131 and below the intermediate transfer belt 61, and overlaps the loading surface 131a and the intermediate transfer belt 61 as viewed in the direction of gravitational force. The back plate portion 134b has an approximately flat plate shape provided to consecutively extend downward from an end portion at the side in the backward direction B of the top plate portion 134a, and is arranged away from the loading tray 131 in the backward direction B. The back plate portion 134b is able to constitute a part of the exterior of the image forming apparatus 1 when being located on the same plane as the downstream end surface 11a of the housing 1a.

In the second exemplary embodiment, the extension portion 136 is provided with a tray-side engagement portion 111, which engages with the second cover portion 134 in a detachable manner, and the image forming apparatus 1 is provided with a main body-side engagement portion 112, which engages with the second cover portion 134 in a detachable manner. Moreover, the second cover portion 134 is provided with a first cover-side engagement portion 113, which engages with the tray-side engagement portion 111 in a detachable manner at the downstream side in the mounting direction DI, and a second cover-side engagement portion 114, which engages with the main body-side engagement portion 112 in a detachable manner at the upstream side in the mounting direction D1. The first cover-side engagement portion 113 is an example of an engagement portion. The tray-side engagement portion 111 is an example of an engagement-receiving portion, with which the first cover-side engagement portion 113 engages when the loading tray 131 is in the extension state and has been mounted to the housing 1a. The main body-side engagement portion 112 is an example of a restriction portion, and restricts the second cover portion 134 from moving beyond the first position in the pulling-out direction D2.

In the second exemplary embodiment, the tray-side engagement portion 111 and the first cover-side engagement portion 113 are formed in claw shapes which engage with each other in a detachable manner. While the tray-side engagement portion 111 and the first cover-side engagement portion 113 are configured to engage with each other by coming close to each other and running on each other, the tray-side engagement portion 111 and the first cover-side engagement portion 113 disengage from each other by receiving a predetermined disengagement force in the direction of drawing away from each other. Similarly, the main body-side engagement portion 112 and the second cover-side engagement portion 114 are formed in claw shapes which engage with each other in a detachable manner. While the main body-side engagement portion 112 and the second cover-side engagement portion 114 are configured to engage with each other by coming close to each other and running on each other, the main body-side engagement portion 112 and the second cover-side engagement portion 114 disengage from each other by receiving a predetermined disengagement force in the direction of drawing away from each other. Moreover, in a state in which the second cover-side engagement portion 114 has engaged with the main body-side engagement portion 112, the second cover portion 134 is not allowed to move in the pulling-out direction D2. Thus, the main body-side engagement portion 112 has the function of a stopper which restricts the movement in the pulling-out direction D2 of the second cover portion 134. While, in the second exemplary embodiment, a case where each of the tray-side engagement portion 111, the main body-side engagement portion 112, the first cover-side engagement portion 113, and the second cover-side engagement portion 114 is formed in a claw shape has been described, the second exemplary embodiment is not limited to this case.

In the state illustrated in FIG. 8, the second cover-side engagement portion 114 is engaging with the main body-side engagement portion 112 and the first cover-side engagement portion 113 is engaging with the tray-side engagement portion 111. At this time, the second cover portion 134 is held by engaging with the housing 1a and the loading tray 131 in the state of being contained inside the housing 1a. The back plate portion 134b of the second cover portion 134 constitutes an exterior of the image forming apparatus 1. In a case where, in the state illustrated in FIG. 8, the loading tray 131 has been pulled out from the image forming apparatus 1, the second cover-side engagement portion 114 is caused to engage with the main body-side engagement portion 112, so that the second cover portion 134 is held by engaging with the housing 1a in the state of being contained inside the housing 1a. Even in a state in which the loading tray 131 has been pulled out from the image forming apparatus 1, the second cover portion 134 constitutes an exterior of the image forming apparatus 1.

Below the intermediate transfer belt 61, the first cover portion 66 and the second cover portion 134 are arranged in such a way as to protect sheets S contained in the loading tray 131. Moreover, as with the first exemplary embodiment, in a case where the loading tray 131 is located in the mounted position, at least a part of the second cover portion 134 has an area Arl which is located downstream of the first cover downstream end 66B in the mounting direction D1 and overlaps the intermediate transfer belt 61 and the loading surface 131a as viewed in the direction of gravitational force. Thus, the second cover portion 134 has the area Ar1, which, when the second cover portion 134 is located in the first position, is located below the intermediate transfer belt 61 in the upward and downward directions and does not overlap the first cover portion 66 as viewed in the upward and downward directions. The second cover portion 134 has an area Ar2 which, when the second cover portion 134 is located in the first position, is located below the intermediate transfer belt 61 in the upward and downward directions and overlaps the first cover portion 66 as viewed in the upward and downward directions. The image forming apparatus 1 is provided with an area Ar0 in which the second cover portion 134 and the first cover portion 66 do not overlap each other, the first cover portion 66 does not exist between the intermediate transfer belt 61, the loading tray 131, and the sheet S, and only the second cover portion 134 exists therebetween.

A case where the loading tray 131 being in the extension state, in which the loading tray 131 has been extended with use of the extension portion 136, is inserted into the image forming apparatus 1 is described with reference to FIGS. 9A and 9B. FIG. 9A illustrates a state in which, when the loading tray 131 has been inserted into the image forming apparatus 1, the tray-side engagement portion 111 engages with the first cover-side engagement portion 113 and the second cover portion 134 moves in the mounting direction D1 together with the loading tray 131.

In response to the insertion operation for the loading tray 131, the engagement between the second cover-side engagement portion 114 and the main body-side engagement portion 112 is released. A disengagement force required for releasing the engagement between the second cover-side engagement portion 114 and the main body-side engagement portion 112 is set weaker than a force required for the mounting operation for the loading tray 131. This enables preventing or reducing a decrease in operability in mounting the loading tray 131. Thus, the user is able to insert the loading tray 131 into the housing 1a with a normal operation force, thus releasing the engagement between the second cover-side engagement portion 114 and the main body-side engagement portion 112.

FIG. 9B illustrates a state in which, in the extension state, in which the loading tray 131 has been extended with use of the extension portion 136, the loading tray 131 has been completely inserted into the image forming apparatus 1. The extension portion 136 and the second cover portion 134 are in the state of protruding in the mounting direction D1 from the back of the housing 1a, so that the second cover portion 134 is protecting, from dust or from being smudged, sheets S having protruded to the outside of the housing 1a.

At this time, as with the state illustrated in FIG. 8, below the intermediate transfer belt 61, the first cover portion 66 and the second cover portion 134 are arranged in such a way as to protect sheets S contained in the loading tray 131. Here, in a case where the loading tray 131 is located in the mounted position, at least a part of the second cover portion 134 has a portion which is located downstream of the first cover downstream end 66B in the mounting direction D1 and overlaps the intermediate transfer belt 61 and the loading surface 131a as viewed in the direction of gravitational force. This portion is referred to as an area Ar1 as with the case illustrated in FIG. 8. At this time, the upstream end in the mounting direction D1 of the second cover portion 134 is located upstream of the first cover downstream end 66B. Thus, the top plate portion 134a of the second cover portion 134 has an area Ar1 which, when the second cover portion 134 is located in the second position, is located below the intermediate transfer belt 61 in the upward and downward directions and does not overlap the first cover portion 66 as viewed in the upward and downward directions.

The top plate portion 134a has an area Ar2 which, when the second cover portion 134 is located in the second position, is located below the intermediate transfer belt 61 in the upward and downward directions and overlaps the first cover portion 66 as viewed in the upward and downward directions. Thus, even when the second cover portion 134 is located in the second position, the first cover downstream end 66B, which is a downstream end in the mounting direction D1 of the first cover portion 66, overlaps the second cover portion 134 as viewed in the direction of gravitational force. The image forming apparatus 1 is provided with an area Ar0 in which, as viewed in the upward and downward directions, the second cover portion 134 and the first cover portion 66 do not overlap each other, the first cover portion 66 does not exist between the intermediate transfer belt 61, the loading tray 131, and the sheet S, and only the second cover portion 134 exists therebetween.

When the user moves the loading tray 131 in the pulling-out direction D2 from the state illustrated in FIG. 9B, the second cover portion 134 moves in the pulling-out direction D2 integrally with the loading tray 131 by the engagement between the tray-side engagement portion 111 and the first cover-side engagement portion 113. When the user further continues the pulling-out operation for the loading tray 131, the main body-side engagement portion 112 and the second cover-side engagement portion 114 engage with each other again and the second cover portion 134 is thus restricted from moving in the pulling-out direction D2, so that the engagement between the tray-side engagement portion 111 and the first cover-side engagement portion 113 is released.

Here, a force required for releasing the engagement between the tray-side engagement portion 111 and the first cover-side engagement portion 113 is set weaker than a force required for the pulling-out operation for the loading tray 131. In the second exemplary embodiment, a disengagement force for releasing the engagement between the tray-side engagement portion 111 and the first cover-side engagement portion 113 is set to the same degree as or set weaker than a disengagement force for releasing the engagement between the main body-side engagement portion 112 and the second cover-side engagement portion 114. This enables preventing or reducing a decrease in operability in pulling out the loading tray 131. Thus, the user is able to pull out the loading tray 131 from the housing 1a with a normal operation force, thus releasing the engagement between the tray-side engagement portion 111 and the first cover-side engagement portion 113.

Thus, when the user pulls out the loading tray 131 being in the extension state from the housing 1a, the second cover portion 134 moves from the second position to the first position in conjunction with the loading tray 131 moving in the pulling-out direction D2 by the engagement between the first cover-side engagement portion 113 and the tray-side engagement portion 111. Then, when having reached the first position, the second cover portion 134 is restricted by the main body-side engagement portion 112 from moving in the pulling-out direction D2, so that the engagement between the first cover-side engagement portion 113 and the tray-side engagement portion 111 is released.

As mentioned above, according to the image forming apparatus 1 in the second exemplary embodiment, the second cover portion 134 has the area Arl, which, when the second cover portion 134 is located in the first position, is located below the intermediate transfer belt 61 in the upward and downward directions and does not overlap the first cover portion 66 as viewed in the upward and downward directions. This enables providing an area in which the first cover portion 66 and the second cover portion 134 do not overlap each other in the upward and downward directions, so that it is possible to attain a reduction in size with regard to the height of the apparatus main body. Thus, by avoiding overlapping in the upward and downward directions between the second cover portion 134 and the first cover portion 66, it is possible to reduce the size of the apparatus with regard to the height direction while also preventing sheets S from being smudged inside the apparatus.

According to the image forming apparatus 1 in the second exemplary embodiment, when the user pulls out the loading tray 131 from the second position, the second cover portion 134 is pulled into the housing 1a in conjunction with the loading tray 131 by the engagement between the first cover-side engagement portion 113 and the tray-side engagement portion 111. Therefore, since it is not necessary to use another member such as an elastic member, it is possible to decrease the number of parts.

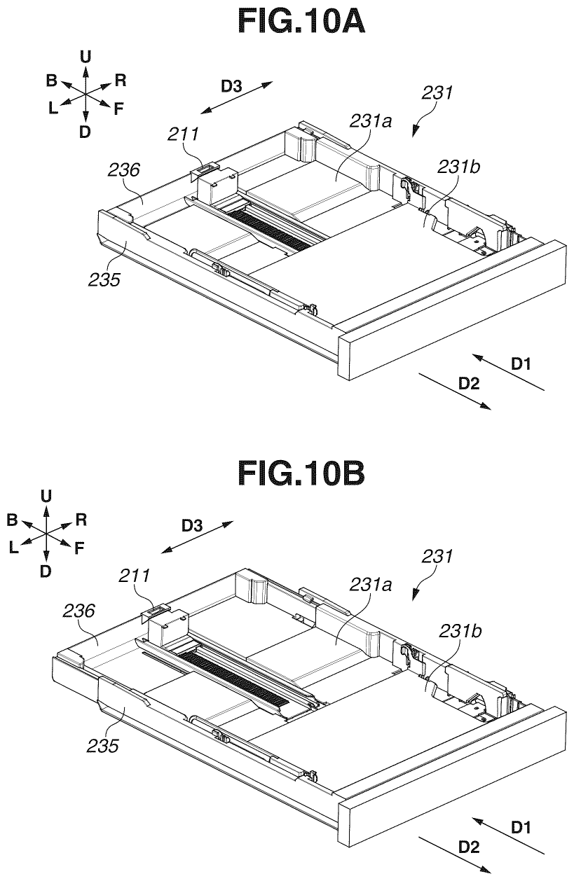

A third exemplary embodiment of the present disclosure is described in detail with reference to FIGS. 10A and 10B to FIGS. 12A and 12B. The configuration of the third exemplary embodiment differs from that of the first exemplary embodiment in that a second cover portion 234 is attached to a loading tray 231. However, the other constituent elements are similar to those in the first exemplary embodiment and are assigned the respective same reference characters as those in the first exemplary embodiment, so that the detailed description thereof is omitted here.

### Configurations of Loading Tray and Second Cover Portion

A configuration of the loading tray 231 is described with reference to FIGS. 10A and 10B. As with the first exemplary embodiment, the loading tray 231 includes a tray main body 235 and an extension portion 236, which is supported in such a way as to be able to slide in the mounting direction DI and the pulling-out direction D2 with respect to the tray main body 235.

FIG. 10A illustrates a normal state in which the loading tray 231 has become shortened with the extension portion 236 located at the side having moved in the pulling-out direction D2, and FIG. 10B illustrates an extension state in which the loading tray 231 has become extended with the extension portion 236 located at the side having moved in the mounting direction D1. This configuration enables the user to, when loading long sheets on the loading tray 231, extend the loading tray 231 with use of the extension portion 236 to enlarge a containing region for sheets S to be loaded.

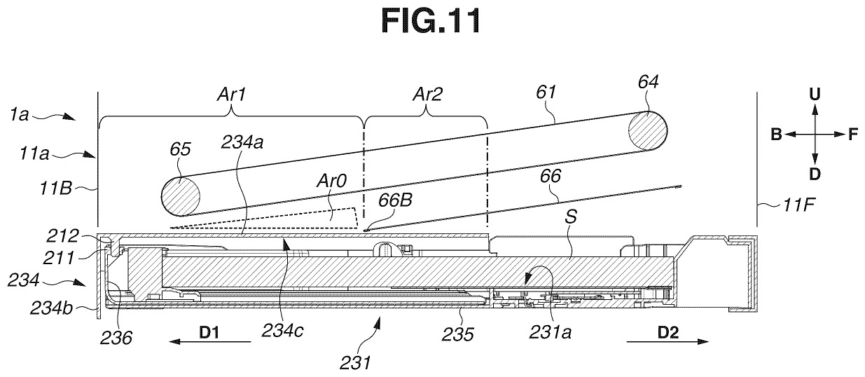

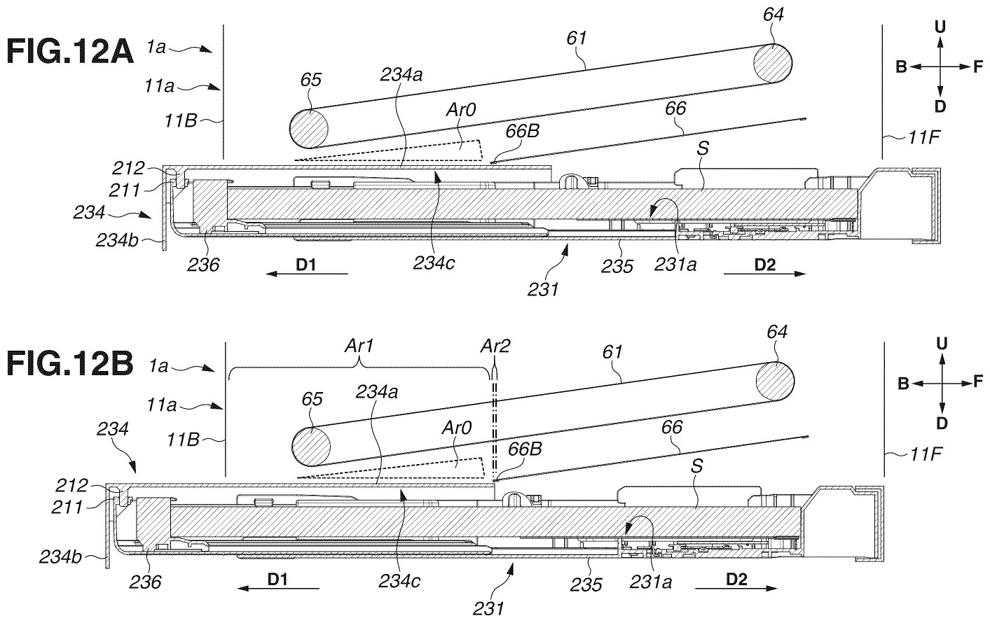

A configuration and operation of the second cover portion 234, which is a feature of the third exemplary embodiment, are described in detail with reference to FIG. 11 and FIGS. 12A and 12B. First, the state in which the loading tray 231 being in the normal state, in which the loading tray 231 is not extended with use of the extension portion 236, has been inserted into and mounted to the image forming apparatus 1 is described with reference to FIG. 11.

The second cover portion 234 is movable in the frontward and backward directions relative to the housing 1a, and includes a top plate portion 234a and a back plate portion 234b. The top plate portion 234a has an approximately flat plate shape which covers the upside of the loading tray 231 and is provided to extend in the horizontal direction, and protects, from dust or from being smudged, sheets S contained in the loading tray 231. The second cover portion 234 includes a cover surface 234c, which covers the upside of the loading tray 231 in conjunction with the first cover portion 66 in the upward and downward directions. In the third exemplary embodiment, the lower surface of the top plate portion 234a serves as the cover surface 234c and covers the upside of the loading tray 231. The second cover portion 234 is arranged above the loading tray 231 and below the intermediate transfer belt 61, and overlaps the loading surface 231a and the intermediate transfer belt 61 as viewed in the direction of gravitational force. The back plate portion 234b has an approximately flat plate shape provided to consecutively extend downward from an end portion at the side in the backward direction B of the top plate portion 234a, and is arranged away from the loading tray 231 in the backward direction B. The back plate portion 234b is able to constitute a part of the exterior of the image forming apparatus 1 when being located on the same plane as the downstream end surface 11a of the housing 1a.

In the third exemplary embodiment, the extension portion 236 is provided with a tray-side engagement portion 211, which engages with the second cover portion 234 in a detachable manner, and the second cover portion 234 is provided with a cover-side engagement portion 212, which engages with the tray-side engagement portion 211 in a detachable manner. The cover-side engagement portion 212 has a pin shape the longitudinal direction of which corresponds to the upward and downward directions, and the tray-side engagement portion 211 is configured with a through-hole through which the cover-side engagement portion 212 of the pin shape penetrates in the upward and downward directions to engage with the tray-side engagement portion 211. Before mounting the loading tray 231 to the housing 1a, the user preliminarily attaches the second cover portion 234 to the extension portion 236 of the loading tray 231 and then mounts the loading tray 231 with the second cover portion 234 attached thereto to the housing la. When the user pulls out the loading tray 231 mounted to the housing 1a, the second cover portion 234 is also pulled out in conjunction with the movement of the loading tray 231. In the third exemplary embodiment, unlike the first exemplary embodiment and the second exemplary embodiment, there is no connection relationship or engagement relationship between the second cover portion 234 and the housing 1a.

The back plate portion 234b of the second cover portion 234 constitutes an exterior of the image forming apparatus 1. Even in a state in which the loading tray 231 has been pulled out from the image forming apparatus 1, the second cover portion 234 constitutes an exterior of the image forming apparatus 1.

Below the intermediate transfer belt 61, the first cover portion 66 and the second cover portion 234 are arranged in such a way as to protect sheets S contained in the loading tray 231. As with the first exemplary embodiment, in a case where the loading tray 231 is located in the mounted position, at least a part of the second cover portion 234 has an area Ar1 which is located downstream of the first cover downstream end 66B in the mounting direction D1 and overlaps the intermediate transfer belt 61 and the loading surface 231a as viewed in the direction of gravitational force. Thus, the second cover portion 234 has the area Ar1, which, when the second cover portion 234 is located in the first position, is located below the intermediate transfer belt 61 in the upward and downward directions and does not overlap the first cover portion 66 as viewed in the upward and downward directions. The second cover portion 234 has an area Ar2 which, when the second cover portion 234 is located in the first position, is located below the intermediate transfer belt 61 in the upward and downward directions and overlaps the first cover portion 66 as viewed in the upward and downward directions. Moreover, the image forming apparatus 1 is provided with an area Ar0 in which the second cover portion 234 and the first cover portion 66 do not overlap each other, the first cover portion 66 does not exist between the intermediate transfer belt 61, the loading tray 231, and the sheet S, and only the second cover portion 234 exists therebetween.

A case where the loading tray 231 being in the extension state, in which the loading tray 231 has been extended with use of the extension portion 236, is inserted into the image forming apparatus 1 is described with reference to FIGS. 12A and 12B. As with the case illustrated in FIG. 11, before the insertion operation, the second cover portion 234 is previously attached to the extension portion 236 of the loading tray 231 by the engagement between the cover-side engagement portion 212 and the tray-side engagement portion 211. FIG. 12A illustrates a state in which, when the loading tray 231 has been inserted into the image forming apparatus 1, the cover-side engagement portion 212 is engaging with the tray-side engagement portion 211 and the second cover portion 234 moves in the mounting direction D1 together with the loading tray 231.

FIG. 12B illustrates a state in which, in the extension state, in which the loading tray 231 has been extended with use of the extension portion 236, the loading tray 231 has been completely inserted into the image forming apparatus 1. The extension portion 236 and the second cover portion 234 are in the state of protruding in the mounting direction D1 from the back of the housing 1a, so that the second cover portion 234 is protecting, from dust or from being smudged, sheets S having protruded to the outside of the housing 1a.

At this time, as with the state illustrated in FIG. 11, below the intermediate transfer belt 61, the first cover portion 66 and the second cover portion 234 are arranged in such a way as to protect sheets S contained in the loading tray 231. Here, in a case where the loading tray 231 is located in the mounted position, at least a part of the second cover portion 234 has a portion which is located downstream of the first cover downstream end 66B in the mounting direction D1 and overlaps the intermediate transfer belt 61 and the loading surface 231a as viewed in the direction of gravitational force. This portion is referred to as an area Ar1 as with the case illustrated in FIG. 11. At this time, the upstream end in the mounting direction D1 of the second cover portion 234 is located upstream of the first cover downstream end 66B. Thus, the top plate portion 234a of the second cover portion 234 has an area Ar1 which, when the second cover portion 234 is located in the second position, is located below the intermediate transfer belt 61 in the upward and downward directions and does not overlap the first cover portion 66 as viewed in the upward and downward directions.

The top plate portion 234a has an area Ar2 which, when the second cover portion 234 is located in the second position, is located below the intermediate transfer belt 61 in the upward and downward directions and overlaps the first cover portion 66 as viewed in the upward and downward directions. Thus, even when the second cover portion 234 is located in the second position, the first cover downstream end 66B, which is a downstream end in the mounting direction D1 of the first cover portion 66, overlaps the second cover portion 234 as viewed in the direction of gravitational force. The image forming apparatus 1 is provided with an area Ar0 in which, as viewed in the upward and downward directions, the second cover portion 234 and the first cover portion 66 do not overlap each other, the first cover portion 66 does not exist between the intermediate transfer belt 61, the loading tray 231, and the sheet S, and only the second cover portion 234 exists therebetween.

As mentioned above, according to the image forming apparatus 1 in the third exemplary embodiment, the second cover portion 234 has the area Ar1, which, when the second cover portion 234 is located in the first position, is located below the intermediate transfer belt 61 in the upward and downward directions and does not overlap the first cover portion 66 as viewed in the upward and downward directions. This enables providing an area in which the first cover portion 66 and the second cover portion 234 do not overlap each other in the upward and downward directions, so that it is possible to attain a reduction in size with regard to the height of the apparatus main body. Thus, by avoiding overlapping in the upward and downward directions between the second cover portion 234 and the first cover portion 66, it is possible to reduce the size of the apparatus with regard to the height direction while also preventing sheets S from being smudged inside the apparatus.

According to the image forming apparatus 1 in the third exemplary embodiment, since the second cover portion 234 is attached to the loading tray 231, it is not necessary to use another member such as an elastic member and it is possible to prevent or reduce the complication of the configuration of the housing 1a.

While, in the third exemplary embodiment, a case where the second cover portion 234 is attached to the extension portion 236 of the loading tray 231 in a detachable manner by causing the cover-side engagement portion 212 of the pin shape to penetrate through the tray-side engagement portion 211 configured with a through-hole has been described, the third exemplary embodiment is not limited to this case. For example, the tray-side engagement portion 211 and the cover-side engagement portion 212 can be made to have claw shapes which engage with each other, such as those of the tray-side engagement portion 111 and the first cover-side engagement portion 113 illustrated in the second exemplary embodiment. Alternatively, a configuration in which the second cover portion 234 is not detachable from the extension portion 236 of the loading tray 231 can be employed. In this case, for example, a configuration in which, to facilitate a loading operation for sheets S to the loading tray 231, the center of turning of the second cover portion 234 is provided at the extension portion 236 and the second cover portion 234 is made capable of turning can be employed. Alternatively, a configuration in which the second cover portion 234 and the extension portion 236 are integrally fixed to each other can be employed.

In each of the above-described exemplary embodiments, a case where the first cover portion 66 is configured with a flat plate-shape member has been described. However, each exemplary embodiment is not limited to this case, but the first cover portion 66 can be a member made from a film-shape sheet having flexibility. Alternatively, a portion at the side in the pulling-out direction D2 of the first cover portion 66 can be a flat plate-shape member, and the other portion at the side in the mounting direction D1 of the first cover portion 66 can be a member made from a film-shape sheet having flexibility. In this case, by setting a region overlapping the second cover portion 34, 134, or 234 in the first cover portion 66 as a member made from a film-shape sheet, it is possible to more reduce the size in the upward and downward directions than in a case where the entirety of the first cover portion 66 is a flat plate-shape member.

In each of the above-described exemplary embodiments, a case where the second cover portion 34, 134, or 234 includes the top plate portion 34a, 134a, or 234a and the back plate portion 34b, 134b, or 234b has been described. However, each exemplary embodiment is not limited to this case, but, for example, as long as at least the top plate portion 34a, 134a, or 234a is provided, even in a case where the back plate portion 34b, 134b, or 234b is not provided, it is possible to provide a dust-proof structure for the upside. Moreover, while, in each of the above-described exemplary embodiments, a case where the top plate portion 34a, 134a, or 234a has an approximately flat plate shape has been described, each exemplary embodiment is not limited to this case.

For example, a partial region overlapping the first cover portion 66 of the top plate portion 34a, 134a, or 234a can be set as a member made from a film shape sheet. In this case, it is possible to more reduce the size in the upward and downward directions than in a case where the entirety of the top plate portion 34a, 134a, or 234a is an approximately flat plate-shape member.

In each of the above-described exemplary embodiments, a case where, in the first position, the second cover portion 34, 134, or 234 is located inside the housing 1a has been described, each exemplary embodiment is not limited to this case. For example, a configuration in which the first position is a position in which the downstream end portion in the mounting direction D1 of the second cover portion 34, 134, or 234 protrudes from the housing 1a can be employed.

In each of the above-described exemplary embodiments, a case where, in the second position, with respect to the second cover portion 34, 134, or 234, only a part thereof protrudes from the housing 1a to the outside thereof has been described, each exemplary embodiment is not limited to this case. For example, the entirety of the second cover portion 34, 134, or 234 can be configured to protrude from the housing 1a to the outside thereof. For example, a position in which, as viewed in the upward and downward directions, the end portion in the pulling-out direction D2 of the second cover portion 34, 134, or 234 coincides with the back cover 11B can be set as the second position. Alternatively, a position in which the end portion of the second cover portion 34, 134, or 234 is away from the back cover 11B in the mounting direction D1 can be set as the second position.

In each of the above-described exemplary embodiments, a case where, in the second position, with respect to the second cover portion 34, 134, or 234, a part thereof protrudes from the housing 1a to the outside thereof has been described, each exemplary embodiment is not limited to this case. For example, in the second position, with respect to the second cover portion 34, 134, or 234, the entirety thereof can be located inside the housing 1a.

In each of the above-described exemplary embodiments, a case where the second cover portion 34, 134, or 234 has an area Ar2 which overlaps the first cover portion 66 in the first position has been described, each exemplary embodiment is not limited to this case. For example, the second cover portion 34, 134, or 234 can be configured not to overlap the first cover portion 66 in the first position.

According to an aspect of the present disclosure, it is possible to attain miniaturization with regard to the height of the apparatus main body.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-133339 filed Aug. 8, 2024, which is hereby incorporated by reference herein in its entirety.

What is claimed is:

1. An image forming apparatus comprising:
a housing;
a photosensitive member on which to form a toner image;
a containing portion having a loading surface on which to load a sheet, the containing portion and configured to contain the sheet and to move along a mounting direction extending between a pulled-out position, in which the containing portion has been pulled out from the housing, and a mounted position, in which the containing portion has been mounted to the housing;
a feeding portion configured to feed the sheet contained in the containing portion;
a transfer belt arranged above the containing portion and configured to allow the toner image to be transferred thereto from the photosensitive member, and to transfer the toner image to the sheet fed by the feeding portion;
a first cover portion arranged above the containing portion and below the transfer belt, the first cover portion overlapping the loading surface and the transfer belt; and
a second cover portion arranged between the containing portion and the transfer belt, and overlapping the loading surface and the transfer belt,
wherein the containing portion includes a main body portion and an extension portion movable in the mounting direction relative to the main body portion,
wherein the containing portion is configured to transition between a first state having a first length in the mounting direction and a second state having a second length in the mounting direction longer than the first length,
wherein, when the containing portion moves from the pulled-out position to the mounted position in the second state, the second cover portion moves in the mounting direction in conjunction with movement of the containing portion,
wherein, in a case where the containing portion is located in the mounted position in the second state, a part of the containing portion is located downstream of a housing downstream end provided on a downstream side in the mounting direction and the second cover portion covers the part of the containing portion, and
wherein, in a case where the containing portion is located in the mounted position, at least a part of the second cover portion is located downstream of a downstream end in the mounting direction of the first cover portion and overlaps the transfer belt and the loading surface.

2. The image forming apparatus according to claim 1,
wherein the photosensitive member is a photosensitive drum, and
wherein, in a direction of an axis of rotation of the photosensitive drum, a length of the first cover portion is longer than a length of the loading surface.

3. The image forming apparatus according to claim 1,
wherein the photosensitive member is a photosensitive drum, and
wherein, in a direction of an axis of rotation of the photosensitive drum, a length of the second cover portion is longer than a length of the loading surface.

4. The image forming apparatus according to claim 1,
wherein the photosensitive member is a photosensitive drum,
wherein, in a direction of an axis of rotation of the photosensitive drum, the housing includes side walls, and
wherein the first cover portion is supported, at both side portions thereof in the direction of the axis of rotation, by the side walls.

5. The image forming apparatus according to claim 1, wherein a downstream end in the mounting direction of the first cover portion overlaps the second cover portion as viewed in a direction of gravitational force.

6. The image forming apparatus according to claim 1, wherein, in a case where the containing portion is located in the mounted position, an upstream end in the mounting direction of the first cover portion is located upstream of an upstream end of the loading surface, and a downstream end in the mounting direction of the second cover portion is located downstream of a downstream end of the loading surface.

7. The image forming apparatus according to claim 1, wherein, with the containing portion in the first state or the second state, inside the housing, the second cover portion and the first cover portion separate the containing portion from the transfer belt.

8. The image forming apparatus according to claim 1,
wherein the second cover portion includes a side plate portion provided to extend in a vertical direction at a downstream portion in the mounting direction, and
wherein the side plate portion constitutes a part of a downstream end portion in the mounting direction of the image forming apparatus.

9. The image forming apparatus according to claim 8, wherein, in a case where the containing portion is in the first state and is located in the mounted position, an outer surface of the side plate portion is flush with the housing downstream end of the housing.

10. The image forming apparatus according to claim 1,
wherein the transfer belt is suspended in a tensioned manner by a first roller and a second roller arranged downstream of the first roller in the mounting direction,
wherein, as viewed in a direction of gravitational force, the first roller overlaps the first cover portion and does not overlap the second cover portion, and
wherein, as viewed in the direction of gravitational force, the second roller overlaps the second cover portion and does not overlap the first cover portion.

11. The image forming apparatus according to claim 1, further comprising:
a primary transfer portion configured to transfer the toner image borne on the photosensitive member to the transfer belt; and
a secondary transfer portion configured to transfer the toner image from the transfer belt to the sheet fed by the feeding portion,
wherein the photosensitive member is arranged above the transfer belt in the direction of gravitational force.

12. The image forming apparatus according to claim 1, wherein the mounting direction leads from a downstream side to an upstream side, in a feeding direction in which the feeding portion feeds a sheet.

13. The image forming apparatus according to claim 1, wherein the mounting direction is parallel to a horizontal direction.

14. The image forming apparatus according to claim 1,
wherein the second cover portion is supported by the housing and is configured to move between a first position and a second position which is located downstream of the first position in the mounting direction and to protrude downstream of the housing downstream end of the housing in the mounting direction, and
wherein, when the containing portion is in the second state and is mounted to the housing, the containing portion moves the second cover portion from the first position to the second position.

15. The image forming apparatus according to claim 14, further comprising an urging portion configured to urge the second cover portion toward the first position,
wherein, when the containing portion in the second state is pulled out from the housing, the second cover portion moves from the second position to the first position by an urging force of the urging portion in conjunction with the containing portion moving toward an upstream side in the mounting direction.

16. The image forming apparatus according to claim 14,
wherein the second cover portion includes an engagement portion,
wherein the containing portion includes an engagement receiving-portion with which the engagement portion engages when the containing portion is in the second state and is located in the mounted position,
wherein the housing includes a restriction portion which restricts the second cover portion from moving toward an upstream side in the mounting direction beyond the first position,
wherein, when the containing portion in the second state is pulled out from the housing, the second cover portion moves from the second position to the first position in conjunction with the containing portion moving to an upstream side in the mounting direction by an engagement between the engagement portion and the engagement-receiving portion, and
wherein, upon reaching the first position, the second cover portion is restricted by the restriction portion from moving toward an upstream side in the mounting direction and the engagement between the engagement portion and the engagement-receiving portion is released.

17. The image forming apparatus according to claim 1. wherein the second cover portion is attached to the containing portion.
